(19) United States
(12) Patent Application Publication
(10) Pub. No.: US 2017/0002475 A1
(43) Pub. Date: Jan. 5, 2017

(54) METHOD FOR MANUFACTURING AS WELL AS USE OF A POLISHED NANOSTRUCTURED METALLIC SURFACE HAVING WATER- AND ICE- REPELLENT CHARACTERISTICS

(71) Applicant: AIRBUS DEFENCE AND SPACE GMBH, Ottobrunn (DE)

(72) Inventors: Tobias STROBL, Munchen (DE); Sonja NIXON, Munchen (DE); Jana HAAG, Munchen (DE); Tobias MERTENS, Munchen (DE)

(21) Appl. No.: 15/125,775

(22) PCT Filed: Mar. 11, 2015
(86) PCT No.: PCT/DE2015/000109

§ 371 Date: Sep. 13, 2016

(30) Foreign Application Priority Data
Mar. 14, 2014 (DE) 10 2014 003 508.5

(51) Int. Cl. C25D 11/24; B64D 15/16; B64D 15/00; B64D 15/12; C25D 11/08; C25D 11/16

(52) U.S. Cl. CPC C25D 11/246; C25D 11/08; C25D 11/16; B64D 15/00; B64D 15/12; B64D 15/16

(57) ABSTRACT

A method for manufacturing a water- and ice-repellent surface on a metallic substrate is disclosed, comprising the steps of a) providing a metallic substrate, b) polishing the metallic substrate, c) contacting of at least a part of the metallic substrate with an electrolyte solution, d) anodizing the metallic substrate of step c) for producing a nanoporous layer on the substrate surface, and e) applying a hydrophobic coating on the nanoporous layer. Thereby the accretion of ice particularly on surfaces of aircraft exposed to a flow is reduced in comparison with the prior art.

### CROSS-REFERENCE TO RELATED APPLICATION

This application claims the benefit of International Application No. PCT/DE2015/000109, filed Mar. 11, 2015, which application claims priority to German Application No. 102014003508.5, filed Mar. 14, 2014, which are hereby incorporated by reference in their entirety.

### TECHNICAL FIELD

The embodiments described herein relate to a method for manufacturing of a water- and ice-repellent surface on a metallic substrate, a metallic substrate having a water- and ice-repellent surface with a nanostructured oxide layer, a water-repellent coaling arranged thereon as well as the use of the metallic substrate on an aircraft for icing protection.

### BACKGROUND

On aircraft, e.g. planes or helicopters, flow surfaces that are exposed to air flow directly or indirectly, are prone to icing in certain flight situations. Ice that is created on the flow surfaces increases the weight of the aircraft and influences the aerodynamics unfavorably, such that in a worst case flow separations and thus a reduction of lift may occur. The accumulation of ice may be prevented through different measures (“anti-icing”) and methods and devices that are capable of removing already accumulated ice (“de-icing”) are known.

It is known, for instance, to heat a leading edge of flow surfaces by means of bleed air from engines, in order to prevent freezing of accumulated water. Removal of bleed air, however, is accompanied by a reduction of power of the engines and should be avoided for the sake of energy efficiency.

Further, it is known to arrange expandable bodies at surface regions prone to icing in order to blast off already built up ice from there. The surface quality of such bodies is, however, limited and in order to achieve an effective operation tolerating a certain ice layer is necessary.

The use of electrically operated heating mats at flow surfaces prone to icing is also known. The heating mats remove ice actively or prevent the accumulation of ice. Particularly at high flow velocities considerable amount of electrical power is required for being able to provide a sufficient heating power. Furthermore, an integration particularly into smaller aircraft or unmanned aerial vehicles is accompanied by a high effort.

Additionally, chemical processes are known, with which a de-icing fluid is continuously dispensed at the flow surfaces prone to icing, what may only be conducted in a limited operating period due to a limited tank size. Additionally, the weight of the de-icing fluid has to be considered in the economic efficiency.

From DE102012001912A1 it is known to manufacture self-cleaning and super hydrophobic surfaces based on titanium dioxide nanotubes. Here, a method for manufacturing a superhydrophobic coating having self-cleaning characteristics on a metallic substrate, a metallic substrate having a superhydrophobic coating and self-cleaning characteristics producible by such a method and the use of an electrolyte solution comprising ammonium sulfate and ammonium fluoride for producing a superhydrophobic coating having self-cleaning characteristics is proposed. For this, a surface made of a titan alloy is surface treated, such that a nanostructure through application of nanotubes is created. Thus, a self-cleaning effect and superhydrophobic characteristics are created.

DE 10 2011 121 545 discloses the manufacturing of a structured surface layer in the sub-micrometer range by means of a laser.

In addition, other desirable features and characteristics will become apparent from the subsequent summary and detailed description, and the appended claims, taken in conjunction with the accompanying drawings and this background.

### SUMMARY

An advantage of the embodiments described herein is to provide an improved, alternative method for treating a surface of a metallic substrate, which makes the manufacturing of a water- and ice-repellent surface possible, wherein the method should preferably be reliably and economically feasible in a large scale.

Provided herein is an embodiment of a method having the features of independent claim 1. Advantageous embodiments and further improvements can be gathered from the subclaims and the following description.

A method for manufacturing a water- and ice-repellent surface on a metallic substrate is proposed, the method comprising the steps of a) providing a metallic substrate, b) polishing the metallic substrate, c) contacting of at least a part of the metallic substrate surface with an electrolyte solution, d) anodizing the metallic substrate of step c) for producing a nanoporous layer on the substrate surface and e) applying a hydrophobic coating on the nanoporous layer.

The polishing serves to produce a very smooth metallic surface, in which almost all imperfections in a macro- and microstructural range in the substrate surface are removed, such that the substrate surface shines. Preferably, the polishing step is realized as mirror polishing, in which the substrate surface gets a strong mirror finish/shine. Through the polishing it is ensured that water and water drops freezing into ice cannot penetrate into recesses or cavities in a macro- and microstructural range. The mechanical anchoring of ice on the substrate surface as one of the essential adhesion mechanisms for ice accretion may therefore be eliminated completely. The success of the polishing step may experimentally be proven through roughness measurements by means of commercially available measuring instruments for determining surface roughnesses.

The polishing may be achieved through different suitable methods, which are particularly characterized by a subsequent removal of material through sanding with progressively finer abrasive bodies, which are at first bound to a solid carrier, such as a cloth or paper. In a final step, which finishes the polishing process, a liquid polishing suspension may he used, which is worked into the material with a particularly soft cloth.

After achieving a desired roughness having a normed arithmetic average roughness Rₐ of exemplarily about 0.02 +/−0.002 μm in the mirror polishing process, the substrate may he cleaned, exemplarily by means of an alcohol or another fluid suitable for removing sanding or polishing residues and/or a polishing suspension,

Relating to the ice adherence, besides the adhesion mechanism of a mechanical anchoring also the attraction between ice and a solid substrate surface through electrostatic forces is considered an essential adhesion mechanism between two solid bodies. The electrostatic attraction may be considerably minimized as the substrate surface comprises a nanostructure with hydrophobic and, at best, superhydrophobic characteristics. In the context of the method according to an embodiment of the invention this means that after removing the macro- and microstructural imperfections a defined nanostructure is produced on the metallic substrate surface by means of an electrochemical process.

Producing a defined nanostructure without again roughening the mirror polished substrate surface regarding its macro- and microstructure, which would negatively influence the ice adherence, is an essential aspect of the anodizing step. The creation of the nanostructure is particularly essential for the wetting behavior of the substrate surface with water. According to the wetting model of Cassie-Baxter water drops and water drops freezing to ice, respectively, cannot penetrate into the nanostructure created on the surface due to the surface tension of water. The water drops rather lie on surface peaks and nanopores of the surface, respectively, which is to be considered hydrophobic and at best superhydrophobic surface behavior with a contact angle of more than 90° (hydrophobic) and more than 150° (superhydrophobic).

After finishing the anodizing process, the roughness should be verified experimentally. For instance, a normed arithmetic average roughness value Rₐ should lie in a range of 0.02-1.5 μm and particularly under 0.1 μm.

Subsequently, in a last process step, a wetting of the nanostructure created on the substrate surface with a chemical solution is conducted, which aims at hydrophobing the surface. Applying may be conducted through a dip coating method. Due to the chemical reaction between the hydrophobic solution (e.g. Fluor silane or Fluor polyether) and the nanostructured oxide layer produced through the anodizing process a superhydrophobic surface is create& The contact angles (water) produced through this process are in a range of 150-163°.

Summing up, the method according to embodiments of the invention creates a roughening of the surface exclusively at a nanoscopic scale, wherein the surface roughness at a microscopic scale is not changed and still is very smooth. The low pore size (preferably under 100 nm. In particular, between 10-40 nm) of the nanostructure in combination with the hydrophobic coating prevents the penetration of water drops on the substrate surface due to the surface tension of water, such that ice adherence is considerably reduced. Resultantly, icing of a metallic substrate may be considerably prevented through this treatment of the surface of a metallic substrate. The energy used for de-icing or for anti-icing on board the aircraft, in which this method is conducted, may be considerably reduced in comparison to aircraft, which are not equipped with surfaces treated according to embodiments of the invention.

In the context of embodiments of the invention every substrate, which completely consists of metal or which comprises a metallic layer on its surface may be considered a “metallic substrate”, The terms “metal” and “metallic” do not necessarily relate to pure metals, but may also include mixtures of metals and metal alloys.

The method according to embodiments of the invention may be applied to metallic substrates, which include aluminum, even though the scope of application is not limited thereto. Preferably, the method according to embodiments of the invention is applied to a metallic substrate, which consists of aluminum. As an alternative, the metallic substrate includes an aluminum alloy.

In an advantageous embodiment the metallic substrate is an aluminum alloy, wherein the alloy preferably additionally comprises at least one further metal selected from a group comprising Cr, Cu, Fe, Mg, Mn, Si, Ti, Zn, Sc, Ag, Li. Such an aluminum alloy is preferably suitable for manufacturing flow surfaces for an aircraft. Exemplarily, this aluminum alloy may additionally comprise lithium, magnesium and silicon.

In a preferred embodiment the amount of aluminum in the alloy may comprise at least 80 percent by weight with regard to the total mass of the alloy, exemplarily between 80 and 98 weight percent.

The electrolyte solution used for anodizing particularly advantageously comprises at least one acid, wherein the electrolyte solution of course may also be realized as a mixture of acids. Exemplarily, the electrolyte solution may comprise at least one mineral acid, such as phosphoric acid and/or sulfuric acid. The electrolyte solution may particularly consist of a mixture of phosphoric acid and sulfuric acid, wherein the mixing ratio may include a range of 8:1 to 1:8, preferably 3:2 phosphoric acid to sulfuric acid. As an alternative, the electrolyte solution may comprise at least one organic acid, such as oxalic acid.

In addition, the electrolyte solution may also be based on an aqueous solution with different salts. In particular, using aqueous electrolyte solutions with salts included therein, particularly preferably salts containing fluoride, is conceivable. In an advantageous embodiment, the electrolyte solution comprises an aqueous solution of at least one salt, in particular at least one ammonium salt.

Particularly advantageously the surface of the metallic substrate is pre-treated after polishing, i.e. directly before anodizing. In an embodiment the substrate surface will be degreased in an alkaline, non-corrosive cleaning bath. Subsequently, the substrate surface may be dipped into a pickling solution momentarily, with a duration between 1 and 20 minutes, particularly between 2 and 5 minutes, in order to ensure a mirror finish. In a preferred embodiment, the pickling solution may be realized by a mixture from different acids or leaches, in particular with a mixture from nitric acid, hydrofluoric acid and water.

In addition, the substrate surface may be cleaned with fully demineralized water following the anodizing step as well as between certain previous process steps.

According to a particularly advantageous embodiment a hydrophobic coating for the substrate surface is produced through a solution, with which the substrate surface is brought into contact This may be conducted through common application methods, such as dipping, centrifuging, flow-coating, brushing or spraying. It is proposed to respectively dip the substrate surface for 0.5 to 20 min and particularly 3 to 8 min into the solution, in order to subsequently use isopropyl alcohol for cleaning. Both these application/cleaning steps may be conducted a plurality of times, preferably twice, in order to subsequently age the substrate surface at a slightly elevated temperature of exemplarily 30 to 90° C. and particularly 50 to 70° C.

The “hydrophobic coating” or “hydrophobing coating” is to be interpreted as a coating, which creates water-repellent characteristics as well as a contact angle to water in a range of 150 to 163° in combination with the nanostructured surface. Due to a repulsion between the superhydrophobic material and the liquid, liquid drops with a small contact surface are developed, which easily run or roll off the surface, respectively. Additionally, such a coating repels dirt and gas parts in the air or in rain water, such as SO₂, NOₓ, salts and hygroscopic dust or residues of chlorides, sulfides, sulfates or acids and insects, respectively. By means of the small contact surface between the superhydrophobic substrate surface and contaminations an adherence is impeded. In total, besides repelling water and ice the metallic substrate may also reduce the contamination.

An embodiment of the invention also relates to a metallic substrate having a water- and ice-repellent coating, which is provided through the method according to the embodiment of the invention. It is preferred that the surface of the metallic substrate having the water- and ice-repellent coating comprises a water contact angle of more than 150° (superhydrophobic).

The metallic substrates having a superhydrophobic coating provided through the method according to embodiments of the invention may particularly be deployed in aircraft, such as airplanes and helicopters. The present metallic substrates having a superhydrophobic coating and self-cleaning characteristics may also be deployed in land based vehicles, rail vehicles or ship vehicles.

An embodiment of the invention further relates to the use of a metallic substrate having a superhydrophobic coating for protection against icing on an aircraft.

The embodiments of the method are also valid for the metallic substrate obtainable through the method as well as the use and vice-versa.

Nevertheless, the use of a metallic substrate having a (super)hydrophobic coating for protection against icing of an aircraft does not exclude that an active device for preventing the accretion of ice (“anti-icing” system) or for removing of accreted ice (“de-icing” system) is deployed, which is based on a common working principle. An aspect of the method according to embodiments of the invention lies in reducing the requirement for primary energy of an anti- or de-icing system by treating the surface of the metallic substrate as described above. Exemplarily, in case the metallic substrate is the leading edge of a flow body, a device for heating or slightly deforming the metallic substrate may be integrated in the interior of the leading edge, exemplarily in form of an electro-thermal and/or an electro-mechanic anti- or de-icing system.

Embodiments of the invention may thus also relate to a hybrid dc-icing system for an aircraft, which comprises a metallic substrate having a surface coating as explained above as a passive component as well as at least one active de-icing device. Particularly preferred, the at least one active de-icing device comprises an electro-thermal de-icing apparatus for preventing of ice accretion or for removing of accreted ice and a mechanical de-icing apparatus for mechanically removing accreted ice. Such a de-icing device is attainable from the European Patent Application EP 13 005 342.

As actively working and e.g. cyclically operable component of a hybrid de-icing system, which component consumes a very small amount of energy, an electro-mechanical subsystem is conceivable, which merely conducts little deformations of the metallic substrate, in order to remove accreted ice. The power demand for this is clearly smaller than with comparable de-icing devices in the prior art, due to the reduced adhesion force.

The fine adjustment of the parameter of the anodizing process may be validated through experiments. The characterization of the ice adhesion of the water- and ice-repellent surface coating produced in this process may be conducted through a dynamic test through an electrodynamic permanent magnet oscillator. For the execution of the oscillating tests a sample of a defined size with a surface having the water- and ice-repellent coating is placed into an icing wind tunnel under realistic icing conditions relevant for the flight of an aircraft which makes use of the probe. The iced sample will then be clamped into an oscillator in a cooling chamber and oscillations near the first resonance frequency of the sample are excited. Through a strain gauge, which is bonded to a side of the sample, which is opposite the ice, the strain of the sample is continuously detected during the oscillation excitation. The removal of the ice layer may be determined through a sudden step in the strain amplitude, which results from the change in the stiffness of the sample composite from metal and ice due to a partial or complete removal of ice from the sample.

Besides measuring the contact angle, in the validation of the water- and ice-repellent characteristics it is further important to determine the surface roughness Rₐ. Thus, it may be prevented that disadvantageous process parameter for the anodizing are chosen, which would lead to a roughening at a microscopic scale of the previously polished surface.

### BRIEF DESCRIPTION OF THE DRAWINGS

The various embodiments will hereinafter be described in conjunction with the following drawing figures, wherein like numerals denote like elements, and:

FIG. 1 shows a mirror-polished body.

FIG. 2 shows a mirror-polished and anodized body.

FIG. 3 depicts pictures of the surface of the body at a nanostructure scale.

FIG. 4 depicts a wetting model of Cassie-Baxter.

FIG. 5 is a view of a second sample body having a mirror polished leading edge.

FIG. 6 is a view of a second sample body having a mirror polished, anodized and hydrophobic leading edge.

FIG. 7 depicts a leading edge of a flow body having a hybrid de-icing system.

### DETAILED DESCRIPTION

The following detailed description is merely exemplary in nature and is not intended to limit the disclosed embodiments or the application and uses thereof. Furthermore, there is no intention to be bound by any theory presented in the preceding background

### DETAILED DESCRIPTION

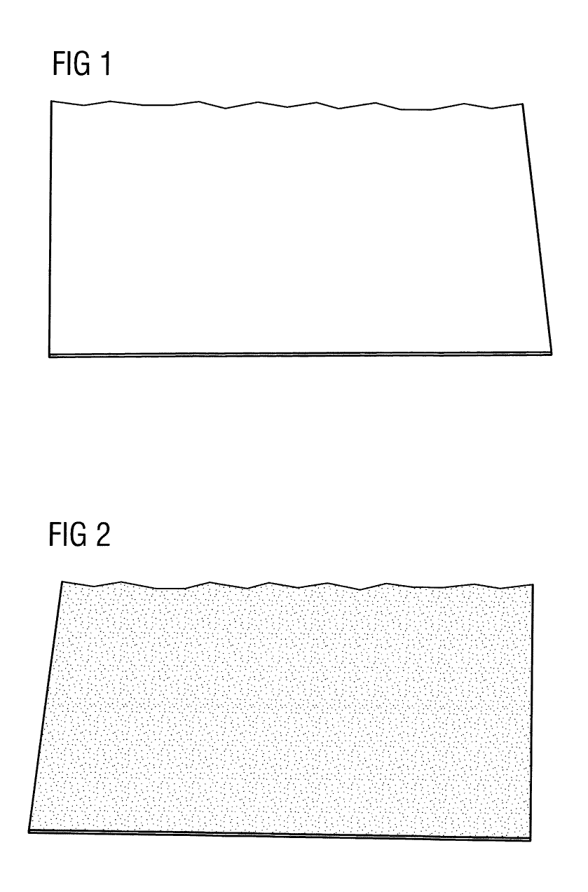

For producing a water- and ice-repellent coating on a metallic substrate initially a body to be coated is provided from an unplated aluminum alloy 2024-T3, which is shown in FIG. 1. Exemplarily, for the sake of validating the method, flat sample bodies having a thickness of 1.6 mm are used, which have an initial surface topology clearly at a microstructural scale.

At first, the body is mirror-polished, wherein the body may exemplarily be manually treated with progressively finer sand papers and, subsequently, is finished with a silica suspension (oxide finishing suspension) on a velvet disk. Afterwards, the suspension and sanding residues are removed from the surface by means of an alkali cleaning agent. The cleaning may be conducted by letting the cleaning agent, such as alcohol, work in for a number of minutes, such as 5 min, at an elevated temperature, such as 65° C.

Afterwards, the body may he pickled in a pickling solution, in order to remove process related contaminations and for creating a reproducible starting surface. The mirror finish visible in FIG. 1 must here be maintained. Subsequent to the pickling, the body is cleaned by means of fully demineralized water, such as through rinsing over a duration of several minutes.

The creation of the nanostructure is subsequently conducted through anodizing. For this purpose, the body is dipped into an electrolyte and is anodized at a predetermined temperature and a predetermined anodizing voltage. In case a mixture from a phosphoric acid and a sulfuric acid is used, the anodizing voltage may be in a range of 5 to 50 V, preferably between 18 and 22 V and the temperature may be in a range of 20 to 40° C., preferably between 22° C. and 28° C. V. The resulting surface, which appears slightly more matt, is illustrated in FIG. 2.

Afterwards, a coating with a hydrophobing coating, such as a Fluor silane or a Fluor, polyether, is conducted, preferably through a dipping process.

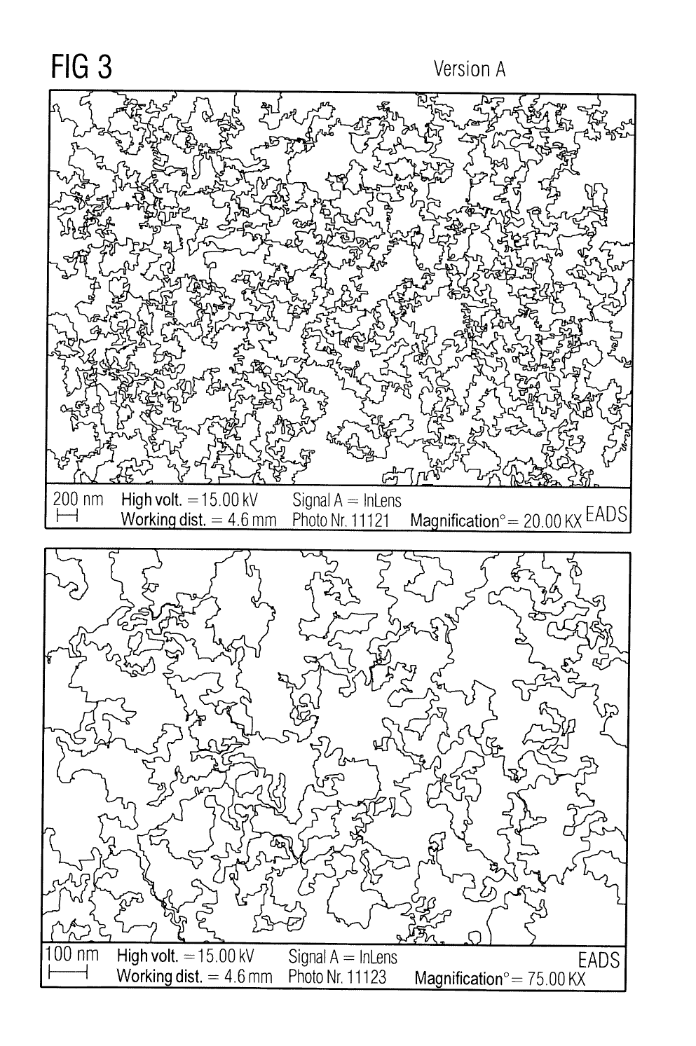

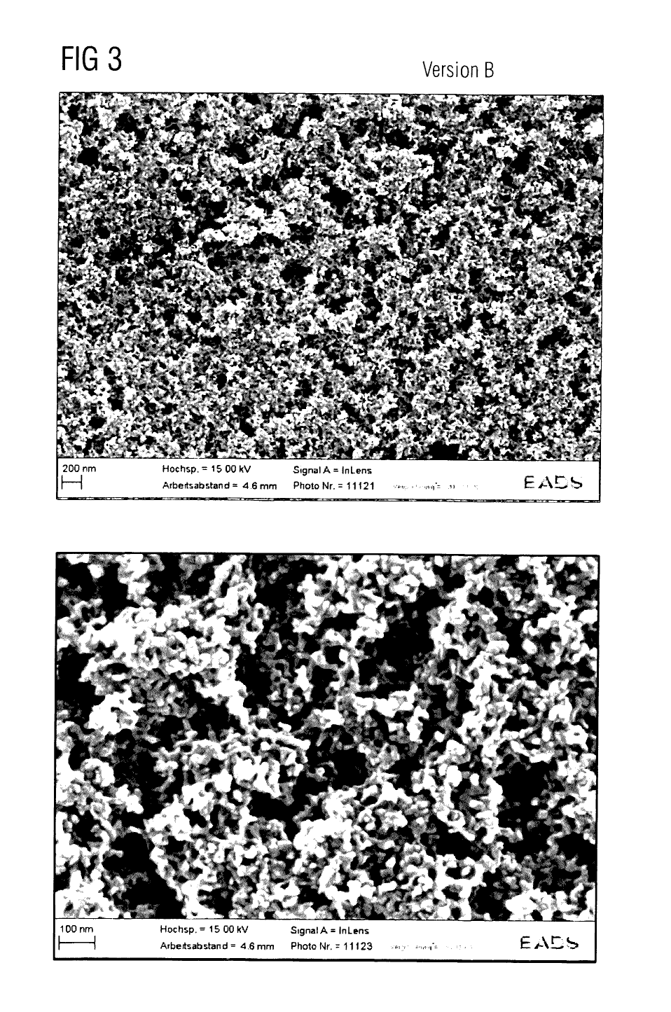

The surface structure at a nanometer scale, which results therefrom, is shown in FIG. 3 in form of two pictures made with a scanning electron micrograph with different resolutions. FIG. 3 (Version A) includes schematic views; FIG. 3 (Version B) includes corresponding photographs.

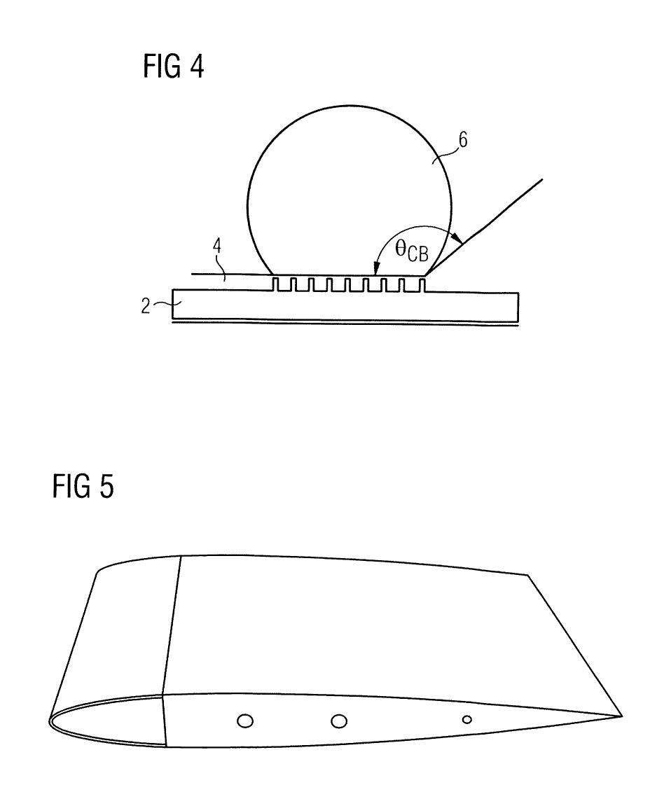

The water repellent characteristics may be determined through measuring the contact angle θ_{CB}, which is shown in FIG. 4. Here, a substrate 2 is illustrated, which comprises a porous surface 4, on which a water drop 6 rests. The contact angle θ_{CB} is the angle between the surface of the water drop 6 and the surface 4 as a contact surface for the water drop 6. The contact angle is a measure for the ability to wet a solid body with a liquid.

The contact angle θ_{CB} is a static contact angle. Additionally, dynamic contact angles may he measured, which are particularly separated into an advancing contact angle (CAA—contact angle advancing) and a receding contact angle (CAR—contact angle receding). The advancing contact angle between a liquid and a solid body is a contact angle, which is assumed during the wetting process. In analogy thereto, the receding contact angle is to be measured during the un-wetting.

Referring to the ice adhesion, particularly the hysteresis is a significant criterion for the wetting behavior of surfaces. This is calculated as the difference between the advancing contact angle and the receding contact angle. For the anodizing parameters explained below and the perfluorether-coating applied onto the nanostructure, a metrologically verifiable advancing contact angle of 160.6*0.59° and a receding contact angle of 158.1±0.14° and thus a hysteresis of 2.5° could be realized.

For evaluating the water- and ice-repellent characteristics a flat sample body having a rectangular cross-section, which sample body has been produced with the method steps (a) to (c) mentioned above, is examined using the oscillating tests mentioned above.

In this context it could be discovered that on a water- and ice-repellent, surface-coated aluminum base substrate the ice in a boundary surface has an adhesion of 0.008*0.001 MPa, while on a purely mirror-polished aluminum sample the ice has an adhesion of 0.018±0.001 MPa. Thus, through anodizing and surface-coating a reduction of ice adhesion in the boundary surface of more than 50% is accomplished.

Moreover, in the case of using phosphorous sulfuric acid as an electrolyte solution, i.e. a mixture of phosphoric acid and sulfuric acid, which in this case comprises a mixing ratio of 3:2 phosphoric acid to sulfuric acid, the roughness may be influenced through variation of the anodizing voltage and the temperature of the electrolyte solution. In the following table it is illustrated, how the mean Rₐ values for four different samples (a), (b), (c) and (d) with different electrolyte temperatures and different anodizing voltages change:

| Sample | (a) | (b) | (c) | (d) |
|---|---|---|---|---|
| Rₐ [μm] | 0.02 +/− 0.002 | 0.073 +/− 0.005 | 0.077 +/− 0.005 | 0.07 +/− 0.007 |
| CAA [°] | 151.5 +/− 1.21 | 160.6 +/− 0.59 | 158.6 +/− 0.56 | 160.0 +/− 0.37 |
| CAR [°] | 136.3 +/− 1.48 | 158.1 +/− 0.14 | 155.8 +/− 0.21 | 156.5 +/− 0.47 |
| CAH [°] | 15.2 | 2.5 | 2.9 | 3.5 |
| Voltage [V] | 18 | 18 | 18 | 22 |
| Temperature [° C.] | 20 | 26 | 30 | 26 |

The sample (a) comprises the lowest Rₐ value, which lies at 0.02 μm±0.002 μm. By way of comparison, the contact angle hysteresis, which is referred to as CAH (“contact angle hysteresis”) is a maximum with 15.2°. The advancing contact angle (CAA) lies at 151.5°*1.21°, the receding contact angle (CAR) at 136.3°±1.48°. The sample (a) has been anodized with a voltage of 18 V at a temperature of the electrolyte solution of 20° C.

The anodizing voltage is maintained for the samples (b) and (c), while the sample (d) has been treated at an anodizing voltage of 22 V. The electrolyte temperature at (b) and (d) is the same with 26°, sample (c) has been treated with an electrolyte temperature of 30°. The resulting contact angles, hysteresis and roughness values can be gathered from the above table.

From this examination it may be found that the sample (b) has the best ice-repellent behavior due to the contact angle of 160.6°±0.59°, a receding contact angle of 158.1°±0.14° and, resultantly, a hysteresis of 2.5°. This is due to the low density of nanopores. By increasing the temperature of the electrolyte solution in an anodizing process the surface morphology is influenced such that the density of nanopores increases and the pores itselves tend to overgrow,

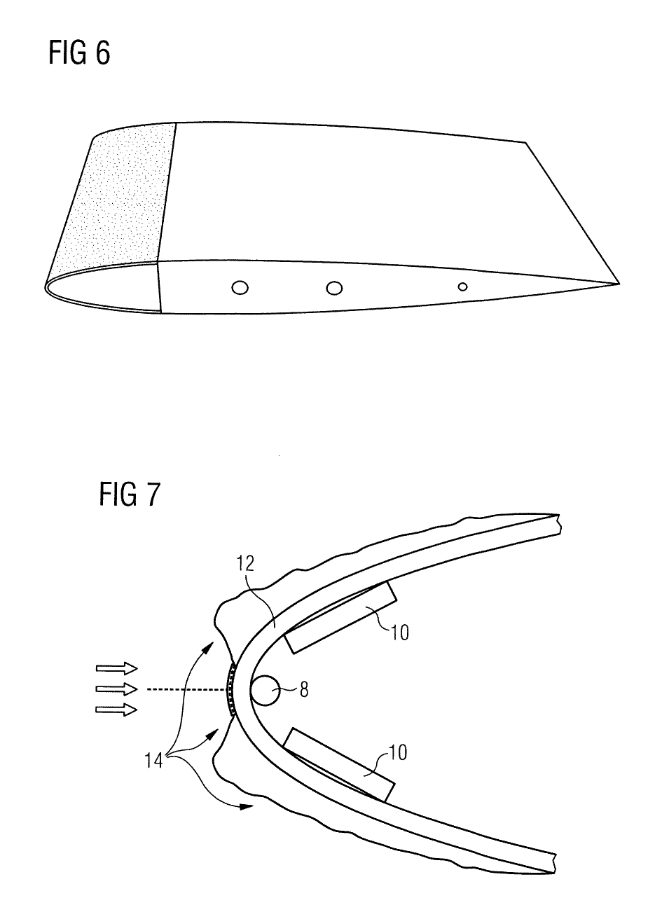

In FIGS. 5 and 6 alternate sample bodies are shown, which are only partially surface-treated in a surface area exposed to icing and which comprise a cross-section, which is similar to the one of a wing profile and comprises a substantially hollow leading edge. FIG. 5 shows a mirror-polished leading edge, while in FIG. 6 a mirror-polished and anodized leading edge is visible.

FIG. 7 shows the integration of an electrothermal de-icing apparatus 8 and two mechanical de-icing apparatuses 10 in a leading edge 12 of a flow surface of an aircraft or a sample body from FIG. 6, respectively. The de-icing apparatuses 8 and 10 as well as the advantageous surface-coating of the leading edge 12 thereby provide a hybrid de-icing system. By means of the ice- and water-repellent surface coating of the leading edge 12 the accretion of ice may be reduced drastically compared to un-treated leading edges 12, such that the requirement for primary energy of the de-icing apparatuses 8 and 10 can be reduced.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

What is claimed is:

1. A method of manufacturing a water- and ice-repellent surface on a metallic substrate, comprising the steps of:
providing a metallic substrate;
polishing the metallic substrate;
contacting at least a part of the metallic substrate with an electrolyte solution;
after the contacting step, anodizing the metallic substrate of stop to produce a nanoporous layer on the substrate surface; and
applying a hydrophobic coating on the nanoporous layer.

2. The method of claim 1, wherein the polishing step includes mirror polishing.

3. The method of claim 1, wherein the metallic substrate is pickled in a pickling solution after polishing, until a mirror finish is obtained.

4. The method of claim 1, wherein the metallic substrate is an aluminum alloy and preferably additionally comprises at least one further metal selected from a group comprising Cr, Cu, Fe, Mg, Mn, Si, Ti, Zn, Sc, Li, Ag.

5. The method of claim 1, wherein the electrolyte solution comprises at least one acid and in particular at least one mineral acid, or at least one organic acid, or a mixture of at least one mineral acid and at least one organic acid.

6. The method of claim 1, wherein the electrolyte solution comprises an aqueous solution of at least one salt, in particular of at least one ammonium salt.

7. The method of claim 1, wherein anodizing the metallic substrate is conducted in an electrolyte solution at a temperature in a range of 20° C. to 40° C. and a voltage of 5 to 50 V.

8. The method of claim 1, wherein applying a hydrophobic coating includes applying a solution, which comprises Fluor slime or Fluor polyether,

9. The method of claim 1, wherein contacting the metallic substrate surface with the electrolyte solution and/or applying the hydrophobic coating on the nanoporous layer is conducted through dipping, centrifuging, flow-coating, brushing or spraying.

10. A metallic substrate having a water- and ice-repellent coating manufactured by the method of claim 1.

11. The metallic substrate of claim 10, wherein the surface of the substrate having a water- and ice-repellent coating comprises a contact angle (θ_{CB}) to water of more than 150°.

12. Use of a metallic substrate having a water- and ice repellent coating according to claim 10 on an aircraft for protection against icing.

13. Use according to claim 12, wherein the water- and ice-repellent coating is arranged at least at a leading edge of at least one flow surface of the aircraft

14. Use according to claim 12, wherein the water- and ice-repellent coating is combined with a hybrid de-icing system.

15. An aircraft, comprising at least one flow surface, which at least at its leading edge comprises a metallic substrate according to claim 10.
